(19) United States
(12) Patent Application Publication
(10) Pub. No.: US 2013/0328874 A1
(43) Pub. Date: Dec. 12, 2013

(54) Clip Surface for Volume Rendering in Three-Dimensional Medical Imaging

(71) Applicants: Mervin Mencias Smith-Casem, Renton, WA (US); Bruce A. McDermott, Bellevue, WA (US); Anil Vijay Relkuntwar, Issaquah, WA (US)

(72) Inventors: Mervin Mencias Smith-Casem, Renton, WA (US); Bruce A. McDermott, Bellevue, WA (US); Anil Vijay Relkuntwar, Issaquah, WA (US)

(73) Assignee: Siemens Medical Solutions USA, Inc., Malvern, PA (US)

(21) Appl. No.: 13/489,998

(22) Filed: Jun. 6, 2012

(51) Int. Cl. G06T 17/00

(52) U.S. Cl. 345/424

(57) ABSTRACT

Volume rendering with a clipping surface is provided in three-dimensional medical imaging. An open curved surface is defined for clipping. The clipping surface is fixed relative to the volume rather than any images, but is editable on multi-planar reconstruction.

### BACKGROUND

The present embodiments relate to medical diagnostic imaging. In particular, clipping is used in volume rendering of medical images.

Ultrasound or other medical imaging modalities may be used to scan a patient. For example, ultrasound is a commonly used imaging modality to visualize an interior volume of a patient. Images of the volume may be computed by a multi-planar reconstruction (MPR) or by volume rendering (VR).

The medical data representing the volume may include information not desired in the VR image. This information may occlude a region of interest in the image. To remove undesired information, a clipping plane may be used. Different embodiments for clipping may be used. In one embodiment, a freely inclinable convex or concave clip surface may be used. Some systems provide for two clipping planes. In other embodiments, the user may adjust, such as on MPR images, the position or orientation of planar clipping planes. The data representing locations on one side of a clipping plane or between two clipping planes is used for VR. However, various approaches to clipping result in different limitations. For example, planar clipping may limit the ability to reduce occlusion.

Instead of clipping planes, a box-shaped editing tool may be used to clip the volume. A surface of the box may be curved. The box may be edited using MPR images. However, the sides of the box are always parallel to the MPR window sides, so the MPR images are rotated to provide editing of the clipping. Controlling the editing of this tool may require manipulation of both the region of interest box (resize) and the MPR images.

In another approach, a single clip plane is provided. There are two variants. In one variant, the VR clip plane has the same position and orientation as one of the MPRs, and the clip plane is adjusted by adjusting the position and/or orientation of the appropriate MPR or by adjusting the VR clip plane graphic in the VR image. In another variant, the VR clip plane is independent of the MPRs, and the VR clip plane position and orientation is adjusted in the VR image (i.e., there is no representation of the VR clip plane in the MPR images). Visualization of a clip plane position in a VR image may be difficult.

In punch or extrusion-style editing tools, the user outlines a border on an MPR or VR image and selects which side of the border is edited. The border is projected into the MPR/VR plane to clip. The border is adjusted by re-initializing the tool (i.e., restarting the outline from scratch) or back-tracking and re-drawing pre-defined sections of the editing border (an “undo” operation). However, re-initializing and undo operations may be inconvenient.

### BRIEF SUMMARY

By way of introduction, the preferred embodiments described below include methods, computer-readable media and systems for volume rendering in three-dimensional medical imaging. An open curved surface is defined for clipping. The clipping surface is fixed relative to the volume rather than any images. Graphics on planar images are used to edit the clipping surface.

In a first aspect, a method is provided for volume rendering in three-dimensional medical imaging. Medical data representing a volumetric portion of a patient is obtained. At least a first image representing a plane through the volumetric portion is displayed. In response to user input with an input device on the first image, an open clipping surface curved along at least two dimensions is defined. A first line in the first image is displayed. The first line represents an intersection of the open clipping surface with the plane. The medical data is clipped with the curved clipping surface. A viewing direction relative to the volumetric portion is changed where a position of the open clipping surface is maintained relative to the volumetric portion during the changing. Based on the viewing direction, volume rendering is performed from the medical data remaining after the clipping. A volume rendered image is displayed based on the volume rendering.

In a second aspect, a system is provided for volume rendering in three-dimensional medical imaging. A memory is operable to store data representing a volume of a patient. A processor is configured to define, in response to input from the user input, a curved clipping surface curved along at least two dimensions and being open, the curved clipping surface fixed to a coordinate system of the data, clip the medical data with the curved clipping surface, and volume render from the medical data remaining after the clipping. A display is operable to display a volume rendered image based on the volume rendering by the processor.

In a third aspect, a non-transitory computer readable storage medium has stored therein data representing instructions executable by a programmed processor for volume rendering in three-dimensional medical imaging. The storage medium includes instructions for displaying intersections of a curved clipping surface on images of a multi-planar reconstruction, receiving user adjustment of a position, orientation, curvature, clipping side, or combinations thereof, the user adjustment being to at least one of the intersections displayed in one of the images of the multi-planar reconstruction, rendering a rendered image from data selected relative to the curved clipping surface, and fixing the curved clipping surface to a volume coordinate system such that the curved clipping surface remains in a same relative position with respect to a volume as a view for the rendering changes.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is a block diagram of one embodiment of a medical imaging system;

FIG. 2 shows example planar medical images and volume rendering image associated with a curved clipping surface, according to one embodiment; and

FIG. 3 is a flow chart diagram of one embodiment of a method for volume rendering in three-dimensional medical imaging.

### DETAILED DESCRIPTION OF THE DRAWINGS AND SPECIFIC EMBODIMENTS

A simple-to-use and flexible editing tool for removing (i.e., clipping) a subset of volume data during volume rendering is provided. A volume rendered image (VR) is edited with a curved clip surface. The position, orientation, and/or shape of the curved clip surface and/or the side of the surface from which volume data is clipped are controlled by manipulating a graphic that is drawn on top of the multi-planar reformatting (MPR) images.

In one embodiment, the curved clip surface is adjusted in real-time without re-initializing the tool. The curved clip surface is fixed to the coordinate system of the transducer so that the clip surface remains in the same relative position with respect to the volume data as the VR is rotated or translated. In various other embodiments, the clip surface orientation is not constrained relative to the MPR planes. The curved clip surface may be positioned and oriented on the MPR images without affecting the positions or orientations of the MPR planes. The clipping region may be adjusted without performing an “undo” operation or re-initializing the tool. A single curved clip surface may be used, with or without symmetry in any intersection with an MPR plane. The clip surface may be used with planes of the MPR having any relative positioning, such as non-orthogonal MPR planes. The user may control the position, orientation, curvature, and side to be clipped of the curved clip surface. Editing with a curved surface, defining a viewing direction on MPRs, and using a single VR clip plane may be provided.

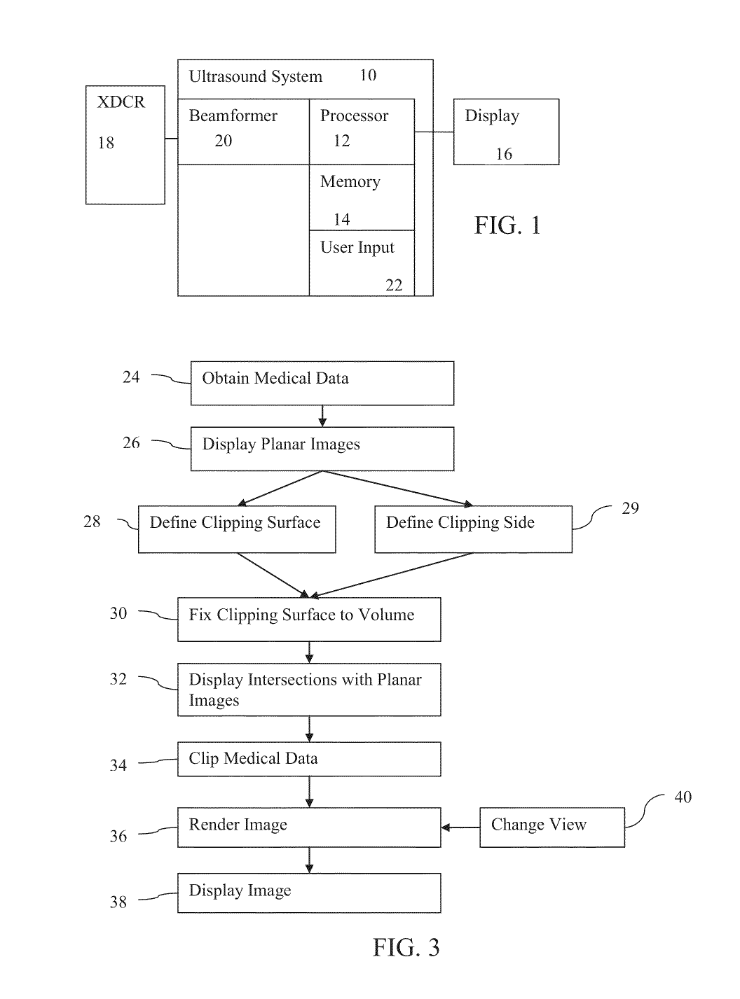

FIG. 1 shows a medical diagnostic imaging system 10 for volume rendering in three-dimensional medical imaging. The system 10 is a medical diagnostic ultrasound imaging system, but may be a computer, workstation, database, server, or other imaging system. Alternatively, the system 10 is another modality of medical imaging system, such as a computed tomography system, a magnetic resonance system, a positron emission tomography system, a single photon emission computed tomography system, or combinations thereof.

The system 10 includes a processor 12, a memory 14, a display 16, a transducer 18, a beamformer 20, and a user input 22. Additional, different, or fewer components may be provided. For example, the system 10 includes a B-mode detector, Doppler detector, harmonic response detector, contrast agent detector, scan converter, filter, combinations thereof, or other now known or later developed medical diagnostic ultrasound system components. As another example, the system 10 does not include the transducer 18 and the beamformer 20, but is instead a computer, server, or workstation for rendering images from stored or previously acquired data.

The transducer 18 is a piezoelectric or capacitive device operable to convert between acoustic and electrical energy. The transducer 18 is an array of elements, such as a one-dimensional, multi-dimensional or two-dimensional array. Alternatively, the transducer 18 is a wobbler for mechanical scanning in one dimension and electrical scanning in another dimension.

The beamformer 20 includes a transmit beamformer and a receive beamformer. The beamformer 20 is connectable with the ultrasound transducer 18. For example, a transducer assembly including the transducer 18 and a cable plugs into one or more transducer ports on the system 10.

The transmit beamformer portion is one or more waveform generators for generating a plurality of waveforms to be applied to the various elements of the transducer 18. By applying relative delays and apodizations to each of the waveforms during a transmit event, a scan line direction and origin from the face of the transducer 18 is controlled. The delays are applied by timing generation of the waveforms or by separate delay or phasing components. The apodization is provided by controlling the amplitude of the generated waveforms or by amplifiers. To scan a region of a patient, acoustic energy is transmitted sequentially along each of a plurality of scan lines. In alternative embodiments, acoustic energy is transmitted along two or more scan lines simultaneously or along a plane or volume during a single transmit event.

The receive beamformer portion includes delays, phase rotators, and/or amplifiers for each of the elements in the receive aperture. The receive signals from the elements are relatively delayed, phased, and/or apodized to provide scan line focusing similar to the transmit beamformer, but may be focused along scan lines different than the respective transmit scan line. The delayed, phased, and/or apodized signals are summed with a digital or analog adder to generate samples or signals representing spatial locations along the scan line. Using dynamic focusing, the delays, phase rotations, and/or apodizations applied during a given receive event or for a single scan line are changed as a function of time. Signals representing a single scan line are obtained in one receive event, but signals for two or more (e.g., 64) scan lines may be obtained in a single receive event. In alternative embodiments, a Fourier transform or other processing is used to form a frame of data by receiving in response to a single transmit.

The system 10 uses the transducer 18 to scan a volume. Electrical and/or mechanical steering by the beamformer 20 allows transmission and reception along different scan lines in the volume. Any scan pattern may be used. In one embodiment, the transmit beam is wide enough for reception along a plurality of scan lines, such as receiving a group of up to 24 or more (e.g., 64) receive lines for each transmission. In another embodiment, a plane, collimated or diverging transmit waveform is provided for reception along a plurality, large number, or all scan lines.

Ultrasound data representing a volume is provided in response to the scanning. A frame of data is acquired by scanning over a complete pattern with the beamformer. The frame of data represents a volume, such as the heart or fetus. The ultrasound data is beamformed, detected, and/or scan converted. The ultrasound data may be in any format, such as polar coordinate, Cartesian coordinate, Cartesian coordinate with polar coordinate spacing between planes, or other format. In other embodiments, the ultrasound data is acquired by transfer, such as from a removable media or over a network. Other types of medical data representing a volume may be acquired.

The memory 14 is a buffer, cache, RAM, removable media, hard drive, magnetic, optical, or other now known or later developed memory. The memory 14 may be a single device or group of two or more devices. The memory 14 is shown within the system 10, but may be outside or remote from other components of the system 10.

The memory 14 stores the ultrasound data. For example, the memory 14 stores flow components (e.g., velocity, energy or both) and/or B-mode ultrasound data. The medical image data is a three-dimensional data set, or a sequence of such sets. For example, a sequence of sets over a portion, one, or more heart cycles of the heart are stored. As another example, a single set (e.g., frame) of data representing the volume at a given time or range of time is stored. The data of each set (frame of data) represents a volume of a patient, such as representing a portion or all of the heart.

For real-time imaging, the ultrasound data bypasses the memory 14, is temporarily stored in the memory 14, or is loaded from the memory 14. Real-time imaging may allow delay of a fraction of seconds, or even seconds, between acquisition of data and imaging. For example, real-time imaging is provided by generating the images substantially simultaneously with the acquisition of the data by scanning. Substantially provides for processing delay. While scanning to acquire a next or subsequent set of data, images are generated for a previous set of data. The imaging occurs during the same imaging session used to acquire the data. The amount of delay between acquisition and imaging for real-time operation may vary, such as a greater delay for initially locating planes of a multi-planar reconstruction with less delay for subsequent imaging. In alternative embodiments, the ultrasound data is stored in the memory 14 from a previous imaging session and used for imaging without concurrent acquisition.

The memory 14 is additionally or alternatively a non-transitory computer readable storage medium with processing instructions. The memory 14 stores data representing instructions executable by the programmed processor 12 for volume rendering in three-dimensional medical imaging. The instructions for implementing the processes, methods and/or techniques discussed herein are provided on computer-readable storage media or memories, such as a cache, buffer, RAM, removable media, hard drive or other computer readable storage media. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one embodiment, the instructions are stored on a removable media device for reading by local or remote systems. In other embodiments, the instructions are stored in a remote location for transfer through a computer network or over telephone lines. In yet other embodiments, the instructions are stored within a given computer, CPU, GPU, or system.

The user input 22 is a button, slider, knob, keyboard, mouse, trackball, touch screen, touch pad, combinations thereof, or other now known or later developed user input device. The user may operate the user input 22 to position a clipping surface (e.g., clipping object), set rendering values (e.g., select a type of rendering or set an offset viewing angle), or operate the system 10. The processor 12 defines the clipping surface and volume renders a selected sub-volume in response to user activation or user sub-volume selection with the user input 22. For example, the user selects an application (e.g., valve view), selects a clipping position, selects a clipping orientation, selects a clipping curvature, and/or otherwise defines a curved clipping surface with the user input 22. In response, the processor 12 generates one or more volume renderings.

The processor 12 is a general processor, digital signal processor, three-dimensional data processor, graphics processing unit, application specific integrated circuit, field programmable gate array, digital circuit, analog circuit, combinations thereof, or other now known or later developed device for processing medical data or managing a user interface. The processor 12 is a single device, a plurality of devices, or a network. For more than one device, parallel or sequential division of processing may be used. Different devices making up the processor 12 may perform different functions, such as a user interface processor and an image rendering graphics processing unit operating separately.

In one embodiment, the processor 12 is a control processor or other processor of a medical diagnostic imaging system, such as a medical diagnostic ultrasound imaging system processor. In another embodiment, the processor 12 is a processor of an imaging review workstation or PACS system. The processor 12 operates pursuant to stored instructions to perform various acts described herein, such as acts for positioning an open, curved surface established relative to the volume rather than image planes.

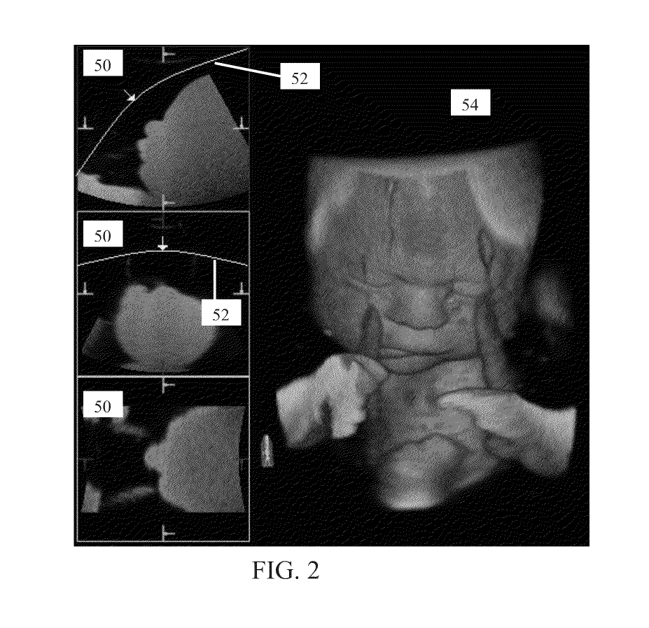

The processor 12 generates a planar image representing a plane in the volume. In one example embodiment, the processor 12 generates a multi-planar reconstruction from a frame of data. For example, FIG. 2 shows three orthogonal planar images 50 generated from data representing a volume including a fetus within a patient. Only one, two, or more than three planar images 50 may be generated. Non-orthogonal positioning of the planes may be used.

The position of the plane or planes relative to the volume is set by the user. For example, the user may scroll to move a plane orthogonal to a current position of the plane. Trackball or pointer device may be used to position and resize the planes. Controls for rotation along any axis may be provided. In alternative embodiments, the processor 12 uses pattern matching, filtering, feature tracking, or other processing to automatically position the plane or planes. The planes may be automatically set to be orthogonal to each other, but other relationships (e.g., angles) with or without pre-determination may be used.

The data for the MPR images is extracted from the frame of data representing the volume. Once positioned, the data from the volume is mapped to the plane. For the locations on the plane (e.g., pixel locations), the data from the nearest location in the volume grid (e.g., voxel) is selected. Alternatively, data for each plane location is interpolated from two or more adjacent volume locations. In an alternative embodiment, the planar image is for a scan plane separately acquired from the volume data or acquired as part of scanning the volume. Rather than extraction from the volume, the planar scan data is used to generate the image, such as a single or bi-plane B-mode image.

The planar image is used to position a clipping surface. The processor 12, in conjunction with the user input 22, generates the clipping surface. The clipping surface is an open three-dimensional surface. The surface may be flat or curve along any dimension. Rather than enclosing a sub-volume, the open surface extends from one edge of the scanned volume to another or has a circumference along one or more edges of the volume. The open surface may intersect only one edge for an entire circumference. The open surface may intersect two or more edges of the volume. In alternative embodiments, the clipping surface is an enclosed volumetric surface.

The surface is predetermined. For example, the surface is set as a concave or convex surface. The user may control different characteristics of the curved surface, such as the curvature along one or more dimensions, the orientation (e.g., rotation), the position, and/or the direction of clipping (e.g., the side of surface to be clipped). Alternatively, the surface may be created by the user, such as provided by user selection of vertices or tracing to define.

The clipping surface is generated by the processor 12 in response to input from the user input 22. The user input 22 may indicate selection of activation of the clipping surface, such as selection of an icon, menu item, or application tool (e.g., a “clipping” tool). The user input 22 may indicate designation of location, size, or orientation of the clipping surface. Using the multi-planar reconstructions, the user may indicate in one or more of the multiple images the characteristics in all three-dimensions.

In a first instance, the clipping surface is defined. A clipping representation is not provided in the planar or volume rendered images since the surface has not yet been initiated. Using a default surface, tracing, or other input, the clipping surface is placed relative to the volume. For example, the user selects a location on a planar image indicating a center of the surface. The default surface is positioned with a default orientation and curvature based on the center. Other initial placement may be used, such as automatically placing the surface to remove a largest region associated with average intensities or values below a threshold.

In one embodiment, the intersection of a default curved surface with the planes of one or more two-dimensional images is represented by a graphic overlay, such as the lines 52 shown in FIG. 2. Where the surface intersects multiple planar images, the position, orientation and curvature may be represented in multiple planar images, allowing for visualization along at least two dimensions. In alternative embodiments, intersection with a single plane may be used to control the surface along more than one dimension.

The clipping surface is fixed to a coordinate system of the data. The data is in a scan (e.g., polar) or scan converted (e.g., Cartesian) format. The data represents grid points or voxels. The clipping surface is defined relative to the grid. As a result, the clipping surface is located based on the volume represented by the data rather than images. If the planar image or rendered image is altered, such as changing the plane position or orientation for the MPR or VR, the clipping surface does not change. The clipping surface is pegged to the scanned volume, not the images. Change in the images may result in a change of the intersection of the clipping surface. Alternatively, the clipping surface is fixed relative to the projection plane or planar images.

After the initial placement, the surface may be edited without initiating placement again. The lines 52 may be used to alter the clipping surface from any given location. New positions for the lines 52 are determined based on editing. If the surface is to be changed, the user alters the lines 52. New lines do not have to be created (i.e., no re-initiation). Undo or reversal of previous edits is not needed. Reversal and/or re-initiation may be provided in alternative embodiments.

The user may drag, rotate, shape, or otherwise manipulate the lines 52 in one or more of the images. For example, the user selects between rotation, translation, and curvature adjustment. Once selected, the user clicks on a desired portion of the line or displayed tool connected to the line to then rotate, translate, or change the curvature. By moving a cursor (e.g., click and drag), the line is altered. Other interfaces may be used, such as using a scroll wheel or button in combination with a location of a cursor to alter the line.

For adjusting curvature, the curve may be limited, such as curving pursuant to a given function or being defined by a polynomial. By varying a value of the function, the curvature changes. Only one direction of curvature is provided along a given plane. Alternatively, more complex functions or free tracing may be used. The amount and/or direction of curvature may vary along a given intersection. Flat portions may be incorporated.

The editing of the clipping surface in a given intersection is extrapolated to the rest of the three-dimensional surface. Any function may be used, such as treating the line as a punching mask along the given dimension represented by the line or by altering values of a function defining the three-dimensional shape. The intersection lines 52 on one image 50 may be altered to control the surface along other dimensions. Where changes along one dimension alter the surface along another dimension, any changes to the intersections with the planar images are reflected in the lines 52. The user places or manipulates the clipping surface in one or more planar images for extrapolation of the curved clipping surface.

In alternative embodiments, the processor 12 automatically positions, orients, and sizes the clipping surface. Anatomical features of the patient or predetermined distance may be used to place the clipping surface.

The clipping surface divides the volume into two parts. In one embodiment, a single clipping surface is used. Additional clipping surfaces may divide the parts into sub-parts in other embodiments. A sub-volume (e.g., one of two parts) is clipped. The data representing the sub-volume is removed or not used for volume rendering. The data representing another sub-volume (e.g., the other of the two parts) is maintained and used for volume rendering. Data representing a location on the surface may be treated as clipped or not-clipped.

The user selects the part to be clipped. For example, the user activates a selection function and clicks on one side of the line 52 on an image. The selected side is either maintained or represents the part to be removed or not used. In the example of FIG. 2, an arrow at the line 52 points to the side to be maintained. The side with the arrow represents the data to be clipped. Other selections may be used, such as providing a default selection of the part to be clipped. In another example, the processor 12 selects based on an average voxel value for the two parts. The part with the lowest or highest average value is clipped. In the example of FIG. 2, the part with the lowest average value is clipped.

The processor 12 renders an image from the medical data. The data remaining after clipping is volume rendered. The data for clipped locations is not used for volume rendering. The clipping surface defines locations or voxels. For static imaging, the same frame or volume data set is used for clipping positioning and rendering. For dynamic or real-time operation, the clipping surface is positioned while images from one or more frames of data are displayed, and the resulting volume rendering may be from yet other frames of data. The clipping surface defines the locations used for then selecting the data from which to render the sub-volume or clipped volume.

Any volume rendering may be used, such as projection (e.g., maximum, minimum, alpha blending or other) or surface rendering. The rendering is from a viewing direction. Rays extend in parallel or diverging from a virtual viewer through the clipped volume. Data along each ray is used to determine one or more pixel values. For example, the first datum along each ray that is above a threshold is selected and used for that ray. Other rendering may be used, such fragment and vertex processing. The viewing direction is based on user selection, a default relative to the clipping surface, a default relative to the volume, or other setting.

Any number of images may be volume rendered from the clipped volume (e.g., the selected sub-set). In the example of FIG. 2, one image is volume rendered. Two or more images may be volume rendered based on the same clipping. The different rendered images correspond to different viewing directions. Other characteristics, such as the mapping transform, type of volume rendering, or diverging verses parallel view lines, may be the same or different for the different images.

The viewing direction may be altered or edited. For example, the user rotates a volume rendering, indicating a change in viewing direction. The perspective of the remaining part of the volume is altered based on the changed viewing direction. Since the clipping surface is defined relative to the volume, the clipping surface perspective also changes with the viewing direction. The clipping surface orientation changes with the viewing direction. The clipping surface is a border of the rotated and/or scaled volume.

In one embodiment, the volume rendering is performed and displayed while the clipping surface is configured. Once the clipping surface is initially placed or defined, a sub-volume is selected. The processor 12 renders the image from the clipped volume for substantially simultaneous display. As the user changes the clipping surface, such as translating, rotating, or altering curvature, different locations are included and/or excluded from the clipping. The resulting different sub-volume is used for further volume rendering. The volume rendered images resulting from the changes in the clipping are displayed to assist the user in determining a desired clipping. In alternative embodiments, the volume rendered images are generated after activation of rendering by the user or no changes to the clipping surface for a threshold amount of time.

The display 16 is a CRT, LCD, plasma, monitor, projector, printer, or other now known or later developed display device. The display 16 displays the planar image or images with or without a representation of the clipping surface. The display 16 displays one or more volume rendered images. The volume rendered image generated by the processor 12 is displayed.

In the example of FIG. 2, a quad display is shown. The display 16 is divided into four image regions, but more or fewer image regions may be used. Three of the image regions are for planar images 50, such as planar reconstruction of orthogonal planes in the volume. The clipping surface may be represented on none, one, or more of the planar images 50. In the example of FIG. 2, the clipping surface does not intersect one of the planes but does intersect two of the planes. One of the regions is for display of a volume rendered image 54.

FIG. 3 shows a method for volume rendering in three-dimensional medical imaging. The method is implemented by a medical diagnostic imaging system, a review station, a workstation, a computer, a PACS station, a server, combinations thereof, or other device for image processing medical ultrasound or other types of volume data. For example, the system 10 or computer readable media 14 and processor 12 shown in FIG. 1 implement the method, but other systems may be used.

The method is implemented in the order shown or a different order. For example, act 32 is performed with act 26. Additional, different, or fewer acts may be performed. For example, act 26 is not provided. As another example, act 40 is not provided.

The acts 24-40 are performed in real-time, such as during scanning. The user may view images while scanning. For real-time imaging, the volume data used for any given rendering may be replaced with more recently acquired data. For example, an initial rendering is performed with one set of data. The final rendering is performed with another set of data representing the same or similar (e.g., due to transducer or patient movement) volume. In alternative embodiments, a same data set is used for all of the acts 26-40 either in real-time with scanning or in a post scan review.

In act 24, medical data representing a volume of a patient is obtained. The data is obtained from memory or from scanning. Any modality may be used. In one embodiment, the patient is scanned with ultrasound, such as for B-mode scanning. For scanning, an ultrasound transducer is positioned adjacent, on, or within a patient. The transducer may be positioned directly on the skin or acoustically coupled to the skin of the patient. Intraoperative, intercavity, catheter, transesophageal, or other transducer positionable within the patient may be used to scan from within the patient.

A volume scanning transducer is positioned, such as a mechanical wobbler or multi-dimensional array. The user may manually position the transducer, such as using a handheld probe or manipulating steering wires. Alternatively, a robotic or mechanical mechanism positions the transducer.

The volume region of the patient is scanned. The wobbler or multi-dimensional array generates acoustic energy and receives responsive echoes. In alternative embodiments, a one-dimensional array is manually moved for scanning a volume.

One or more sets of data are obtained. The data of a set is a frame of data representing the volume at a given time or range of times. The set of data represents locations or voxels distributed in a three-dimensional grid, such as N×M×P grid, where N, M, and P are integers greater than 1. The ultrasound data represents a region of a patient.

The ultrasound data corresponds to beamformed data, detected data, and/or scan converted data. Data for multiple planar slices may represent the volume region. Alternatively, a volume scan is used. The region includes tissue, fluid or other structures. Different structures or types of structures react to the ultrasound differently. For example, heart muscle tissue moves, but slowly as compared to fluid. The temporal reaction may result in different velocity or flow data. The shape of a structure or spatial aspect may be reflected in B-mode data. One or more objects, such as the heart, an organ, a vessel, fluid chamber, clot, lesion, muscle, and/or tissue are within the region. The data represents the region.

In act 26, one or more planar images are displayed. The user activates a volume rendering function. Based on the activation, planar images are generated. The planar images may be for default locations, based on a position of the transducer relative to the volume, or set by the user. The user may alter the position and/or orientation of the planes.

The planar images represent planes through the volume. Different images represent different planes. The planes may be orthogonal or have other relative angles. For example, two or more parallel planes spaced along an axis are used. As another example, three orthogonal planes intersecting at a point of interest are used. Any angle between two planes may be used, such as 90 degrees, less than 90 degrees, or more than 90 degrees. In one embodiment, the planar images are part of a multi-planar reconstruction.

In act 28, one or more planar images are used to define a curved clipping surface. The tool creates a volume rendering surface that may be curved or flat. The clipping surface is curved along one, two, or more dimensions, such as having a concave or convex bowl shape. The surface may be symmetric or asymmetric, depending on the algorithm chosen to compute the surface. More complex curvature may be provided.

The curved clipping surface is an open surface. The three-dimensional surface is free of enclosure. For example, the opening of a bowl-shaped surface lies in a single plane or base plane. The opening of the surface is computed to be wide enough to span the largest corner-to-corner distance of the volume's bounding box to insure that the clip surface is capable of spanning the entire volume regardless of surface's orientation. Non-planar openings may be provided. The opening extends across the volume or part of the volume.

The surface is represented by a continuous or step function. Alternatively, a 3D mesh defines the clipping surface. Triangular, hexagonal or other meshes may be used.

The surface is established in response to user input with an input device. The input is relative to one or more of the planar images. The initial position, orientation, and curvature of the clipping tool are set. For example, a default curved surface is positioned relative to a selected point or points on one or more images. The default clipping surface may have a default selection of the side of the surface from which volume data is clipped.

In one embodiment, the initial state of the curved clip surface is defined using a mouse or trackball. The cursor is positioned on an MPR image and the location is selected to define one point in the base plane of the clipping surface. The mouse is dragged away from that point to define the direction of the normal vector of the base plane and the location of the peak of the bowl-shaped surface. As soon as the user moves the cursor from the initial point, the curved line graphics representing the curved clip surface in the MPR images are drawn and updated in real-time as the user is interacting with the tool. Once dragged to the desired location, the user clicks to fix the location of the curvature control point.

In act 29, the clipping side is defined. The cursor is moved to the side of the surface intersection line graphic on which clipping is desired, and a click operation is performed to execute the clipping. An arrow or other graphic may be drawn with the surface intersection line graphic to indicate which side of the surface is clipped.

To simplify the workflow, the surface may be assumed to be symmetric with respect to the surface normal at the curvature control point (i.e., the surface is bowl-shaped) or other rules may be devised to control the initial shape of the surface (e.g., the surface may be an ellipsoidal bowl that's longer along one dimension and shorter along another dimension). Other mouse or trackball-based variants of this initial placement method may be used.

An alternative for defining the initial state of this tool is to initialize the curved clip surface to a pre-defined position, shape, and/or clipping side using preset values set at the factory. The user may then adjust the curved clip surface as desired. The surface may be initially placed without mouse or trackball interaction, such as by placing with a predetermined location and orientation.

After an initial placement, the user adjusts an amount of curvature, position relative to the volume, and/or orientation relative to the volume. Using the user input, the user establishes the characteristics of the clipping surface. For example, the user clicks and drags a point in a displayed line to alter the curvature in a curve setting mode. The dragging may increase or decrease the amount of curvature. Other manipulations of the graphics representing the clipping surface may be used. Alternatively, the user scrolls, selects, or inputs a value representing an amount of curvature. Other inputs may be used.

The clipping surface is edited from a previous instance. The editing is provided without re-initialization. Instead, the user activates the characteristic to be changed and inputs a change. The location, orientation and/or curvature may be changed from one instance to establish another instance. By altering an intersection line on a planar image, the clipping surface may be translated, rotated, or recurved. The clipping side may be changed.

In one embodiment, the position of the clip surface is altered by manipulation of one or more graphics drawn on the MPR images. For example, the user enters a pan mode (e.g., by pressing a button or selecting an item from context-sensitive menu). In this mode, clicking on the surface intersection graphic in one of the MPRs attaches the cursor to that surface intersection graphic, and moving the mouse or trackball pans the graphic. The surface intersection graphic updates as needed in each other MPR in real-time to show the intersection of the surface and the MPR.

The orientation of the clip surface is altered by manipulation of one or more graphics drawn on the MPR images. For example, the user enters a rotate mode (e.g., by pressing a button or selecting an item from a menu). In the rotate mode, clicking on the surface intersection graphic in one of the MPRs defines the point about which the graphic will rotate, and moving the mouse or trackball rotates the graphic. The surface intersection graphic updates as needed in each other MPR in real-time to show the intersection of the surface and the MPR.

The curvature of the clip surface is altered by manipulation of one or more graphics drawn on the MPR images. For example, the user enters a curvature adjustment mode (e.g., by pressing a button or selecting an item from a menu). In this mode, clicking on the surface intersection graphic in one of the MPRs defines the point on the surface that the user will adjust. Moving the mouse or trackball moves the selected point on the surface and changes the shape of the surface. The shape and/or amount of curvature may be constrained by the algorithm used to compute the curved surface. The surface intersection graphic updates as needed in each other MPR in real-time to show the intersection of the surface and the MPR.

Different or the same curvature is shown in the different planar images. Curvature along different dimensions may be adjusted in the different planar images.

The tool's graphics include an icon or icons indicating from which side of the surface volume data is clipped. In the example of FIG. 2, the volume data is clipped on the side of the curved line in which the small yellow arrows lie.

Adjusting the tool's graphics on the MPR images causes the clipping in the VR image to update immediately. Alternatively, update does not occur until a further activation. Change in the clipping surface may result in a different intersection with the planar images. For example, the user changes the position, orientation, or curvature in one planar image. The change to the surface may result in a change to the intersection with another plane. The graphics are updated. The user may cycle between altering graphics on different images to establish a desired clipping surface. Alternatively, change to a single graphic is used. As the planes are varied, the intersection varies. As a result, changing the planes results in different intersection graphics.

In act 30, the clipping surface is fixed to the volume. Since the clipping surface is defined independently of the planes for imaging, the clipping surface may be changed without change to the planes and corresponding planar images. Similarly, changes to the planar images, such as position or orientation, may change the intersection with the clipping surface but do not change the position of the clipping surface relative to the volume to be clipped. The curved clipping surface is fixed to a volume coordinate system such that the curved clipping surface remains in a same relative position with respect to a volume as a view for the rendering changes. The relationship between the clip surface and the volume data is defined on the MPR images, so as the VR image is manipulated, the clip surface follows accordingly. In other words, the clip surface is tied to the volume's local coordinate system rather than to the viewer's (global) coordinate system.

In act 32, the intersections of the curved clipping surface with planes represented by the planar images is displayed on the images. For example, the planar images of a multi-planar reconstruction include a curved or straight line graphic representing the intersection. As another example, an intersection with a given scan plane used to acquire an image is represented with a graphic. Graphics are shown in any of the planar images with a corresponding intersection with the clipping surface. By calculating the intersection, the position of the clipping surface relative to imaged planes may represent the relative positioning. The intersection may be different for a same clipping surface depending on the relative angle of the planes for planar imaging.

In act 34, the medical data acquired in act 24 or subsequently acquired is clipped. The curved clipping surface indicates part of the scanned volume selected for volume rendering. A single clipping surface is used, but multiple clipping surfaces may be provided. An open clipping surface is used, but an enclosed clipping surface may be provided.

By defining the clipping surface in a planar image or multiple planar images representing different planes in the volume, the selection of the sub-volume is performed. The defined clipping surface indicates a clipped volume. Part of the scan volume of interest is selected. The part is a volume itself, such as being formed from locations or voxels distributed in three-dimensions. The part not selected is not used. The data for locations in the non-selected part is removed or not used for volume rendering.

In act 36, the sub-volume defined by the clipping volume is volume rendered. The volume rendering is a projection, surface, or other rendering. The type or other characteristics of the volume rendering are based on predetermined settings or user selections. The data used for the volume rendering is of locations within the sub-volume or clipped volume.

The data representing the volume is medical data. The data represents the patient, such as from a scan of an interior portion of the patient. The data represents the volume at a given time. While the scan may be acquired over a period (e.g., milliseconds or seconds), the result is treated as representing the patient at a given time. For a given time, the same data is used for volume rendering and planar imaging. The different images may change as further data is acquired. For a static display, one set of data is used to generate the different views for frozen display.

By rendering with the clipping, selected data is used for rendering and non-selected or removed data is not. Where a single clipping surface is used, data remaining only after the clipping with the one clipping surface is used for rendering. Multiple clipping surfaces may be used. Intervening tissue or other structure is not included due to clipping. Data outside the clipped volume is not used. The volume rendered image may more clearly represent the tissue or features of interest without occlusion or confusion caused by tissue in-front of or behind relative to the viewing direction.

By adjusting location, orientation, and/or curvature of the clipping surface, different data is selected at different times. Since the rendering relies on the data selection, different renderings result.

The rendering is performed along the viewing direction. The volume is rendered to a two-dimensional display based on a viewer position or perspective established by the viewing direction.

A processor receives the indication from user interface operation or from data processing. For example, a user definition of the clipping surface indicates one or more viewing directions. The shape of the clipping volume may be associated with predefined viewing directions. The indication is provided by orientation of the clipping volume. The user may adjust the viewing angles. The user may select sides or lines relative to the clipping surface after or as part of positioning the clipping surface. The viewing direction is alternatively a default.

In act 38, the images are displayed. The volume rendered image is displayed. The volume rendered image may be displayed without other images. For example, if act 28 is automated by processor 12, it is not necessary to view planar images with clipping surface graphics for positioning of the clipping surface. As another example, MPRs are used for defining the clipping surface, and then the display layout is changed to show only VR images. Any display format may be used. The display may be divided into regions. The different images are displayed in the different regions. For example, the volume rendered image 54 is displayed with planar images 50 as shown in FIG. 2. The images are displayed at a same time, but may be displayed sequentially. For example, three two-dimensional images 50 corresponding to substantially orthogonal planes are displayed in three different quadrants of a screen or display arrangement. A volume rendered image 54 is displayed in another quadrant or section of the display.

The three-dimensional representation is displayed statically. In another embodiment, the data changes as a function of time, such as to show the movement of tissue. The three-dimensional representation is of the same viewing angle, but the data changes to show changes in the tissue from that diagnostic view over time. As the data changes, the volume rendering and resulting display are repeated with the new data.

Similarly, the three-dimensional representation may change as the clipping surface is edited. Using the same or different sets of data, the parts of the volume included in the rendering change. Change of locations being clipped results in different data being used for rendering. The volume rendering is repeated in response to a change in the clipping surface.

The three-dimensional representation is maintained at the selected view until an indication of another view is received in act 40. The user may adjust the viewing directions to provide the desired view. As the user adjusts the view direction, different volume renderings due to the change in perspective are displayed. The adjustment is performed by entering an angle, orienting the clipping volume, moving a line representing the viewing direction, or other mechanism.

The position of the clipping surface is maintained relative to the volumetric portion of the patient. When the viewing direction changes, the relative position of the clipping surface to the volume is maintained. As a result, a perceived orientation of the clipping surface to the viewer changes with a change in the viewing direction. While the clipping surface may not be represented in the volume rendered image, the clipping surface does control the data used for the rendering. The different viewing direction may result in different data relative to the clipping surface being used for any given pixel.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

I (We) claim:

1. A method for volume rendering in three-dimensional medical imaging, the method comprising:
obtaining medical data representing a volumetric portion of a patient;
displaying a first image representing a plane through the volumetric portion;
defining, in response to user input with an input device on at least a first image, an open clipping surface curved along at least two dimensions;
defining, in response to the user input, a clipping side;
displaying a first line in the first image, the first line representing an intersection of the open clipping surface with the plane;
clipping the medical data with the curved clipping surface;
changing a viewing direction relative to the volumetric portion, a position of the open clipping surface maintained relative to the volumetric portion during the changing;
volume rendering, based on the viewing direction and the clipping side, from the medical data remaining after the clipping; and
displaying a volume rendered image based on the volume rendering.

2. The method of claim 1 wherein obtaining comprises obtaining data representing voxels distributed in three dimensions, and wherein displaying the first image comprises displaying a multi-planar reconstruction with the first image and a second image of a different plane through the volumetric portion, and wherein displaying the first line comprises displaying the first line in the first image and a second line in the second image.

3. The method of claim 1 wherein defining comprises defining the open clipping surface as a three-dimensional surface free of enclosure wherein an amount of curvature, the clipping side, position relative to the volume, and orientation relative to the volume are established in response to the user input.

4. The method of claim 1 wherein clipping comprises clipping with the curved clipping surface free of other clipping, and wherein volume rendering from the medical data remaining after the clipping comprises volume rendering from the medical data remaining after only the clipping with the curved clipping surface.

5. The method of claim 1 wherein defining comprises defining the open clipping surface independent of the plane of the first image such that the open clipping surface is changed in position without a change in the plane.

6. The method of claim 1 wherein defining comprises editing the open clipping surface from a previous instance of the open clipping surface without re-initialization of the open clipping surface.

7. The method of claim 1 wherein defining comprises defining the open clipping surface as curved along three dimensions.

8. The method of claim 1 wherein the different planes are at a non-perpendicular angle and wherein displaying the first and second lines comprises displaying with the intersection being a function of the non-perpendicular angle.

9. The method of claim 1 wherein defining comprises defining the open clipping surface as having different curvature at the intersection represented by the first line.

10. The method of claim 1 wherein defining comprises editing the open clipping surface by translation, rotation, and curvature alteration of the first line.

11. The method of claim 1 wherein clipping the medical data with the curved clipping surface comprises selecting part of the volumetric portion.

12. The method of claim 1 wherein changing comprises changing the viewing direction and a perceived orientation of the open clipping surface, and wherein volume rendering comprises rendering to a two-dimensional representation of the volumetric portion as viewed along the viewing direction.

13. A system for volume rendering in three-dimensional medical imaging, the system comprising:
a memory operable to store data representing a volume of a patient;
a user input;
a processor configured to:
define, in response to input from the user input, a curved clipping surface curved along at least two dimensions and being open, the curved clipping surface fixed to a coordinate system of the data;
define, in response to the input form the user input, a clipping side of the curved clipping surface;
clip the medical data with the curved clipping surface; and
volume render from the medical data remaining after the clipping; and
a display operable to display a volume rendered image based on the volume rendering by the processor.

14. The system of claim 13 wherein the processor is configured to generate a multi-planar reconstruction of a plurality of planes through the volume, wherein the curved clipping surface is defined based on user interaction with intersection lines on images of the multi-planar reconstruction, the interaction changing a position, curvature, orientation, or combinations thereof of the intersection lines.

15. The system of claim 13 wherein the processor is configured to volume render from a first view direction and repeat the volume rendering from a second view direction different than the first view direction, an orientation of the curved clipping surface being different for the first and second view directions due to being fixed to the coordinate system.

16. The system of claim 13 wherein the processor is configured to define the curved clipping surface in a first instance begun by initiating placement of the curved clipping surface on a planar image without a clipping representation and allow editing to a second instance without initiating the placement.

17. The system of claim 13 wherein the processor is configured to clip with only the curved clipping surface.

18. In a non-transitory computer readable storage medium having stored therein data representing instructions executable by a programmed processor for volume rendering in three-dimensional medical imaging, the storage medium comprising instructions for:
displaying intersections of a curved clipping surface on images of a multi-planar reconstruction;
receiving user adjustment of a position, orientation, curvature, clipping side, or combinations thereof, the user adjustment being to at least one of the intersections displayed in one of the images of the multi-planar reconstruction;
rendering a rendered image from data selected relative to the curved clipping surface; and
fixing the curved clipping surface to a volume coordinate system such that the curved clipping surface remains in a same relative position with respect to a volume as a view for the rendering changes.

19. The non-transitory computer readable storage medium of claim 18 wherein fixing comprises fixing the curved clipping surface such that the intersections of the curved clipping surface change with a change in the multi-planar reconstruction.

20. The non-transitory computer readable storage medium of claim 18 wherein the curved clipping surface comprises an open surface with curvature in at least two dimensions.
